(19) United States
(12) Patent Application Publication
(10) Pub. No.: US 2024/0316560 A1
(43) Pub. Date: Sep. 26, 2024

(54) IMPROVEMENTS IN OR RELATING TO A MICROFLUIDIC DEVICE

(71) Applicant: LIGHTCAST DISCOVERY LTD, Cambridge, Cambridgeshire (GB)

(72) Inventors: Robert WOOTTON, Cambridge, Cambridgeshire (GB); Thomas Henry ISAAC, Cambridge, Cambridgeshire (GB); William DEACON, Cambridge, Cambridgeshire (GB); Richard Jeremy INGHAM, Cambridge, Cambridgeshire (GB); Timothy James PUCHTLER, Cambridge, Cambridgeshire (GB)

(73) Assignee: LIGHTCAST DISCOVERY LTD, Cambridge, Cambridgeshire (GB)

(21) Appl. No.: 18/577,435

(22) PCT Filed: Jul. 8, 2022
(86) PCT No.: PCT/GB2022/051767

§ 371 Date: Jan. 8, 2024

(30) Foreign Application Priority Data
Jul. 9, 2021 (GB) 2109966.8

(51) Int. Cl. B01L 3/00

(52) U.S. Cl. CPC B01L 3/502792; B01L 3/502715; B01L 2200/04; B01L 2200/0673; B01L 2200/16; B01L 2300/16; B01L 2400/0427; B01L 2400/0487

(57) ABSTRACT

A device for manipulating a microdroplet using optically mediated electrowetting is provided. The device comprising a microfluidic space bounded by: a first composite wall comprising: a first substrate; a first conductor layer on the substrate; a photoactive layer on the first conductor layer; and a first continuous dielectric layer on the photoactive layer having thickness of less than 20 nm; a second composite wall comprising: a second substrate; and a second conductor layer on the substrate.

### FIELD OF THE INVENTION

The present disclosure relates to a microfluidic device, and in particular, a device for manipulating a microdroplet using optically-mediated electrowetting (oEWOD).

### BACKGROUND TO THE INVENTION

Design of devices for manipulating microdroplets using optically-mediated electrowetting is driven by a number of competing effects and observed phenomena.

When focusing on the efficiency of manipulation of microdroplets, it would be preferable in many designs to maximise the speed at which the microdroplets can be manipulated. Improvements in droplet manipulation speed allows for higher throughput of biological experiments. Another aspect of the efficiency of an oEWOD device is the reliability with which droplets can be held stationary within a device, with the minimum number of droplets being lost or moving from their holding positions. The speed with which the microdroplets can be manipulated correlates supra-linearly with the voltage applied. The maximum voltage that can be applied dictates the dielectric thickness required to ensure that the device operates below the breakdown voltage of the dielectric layers. The literature therefore teaches that thick dielectric layers are required in order to operate safely at the high voltages required to maximise speed. The reliability of droplet holding is determined by the complex interplay between the droplet holding force and the strength of any extraneous forces that might dislodge the droplets from their holding locations, particularly dielectrophoretic effects and the motion of the surrounding carrier phase and the constituents of the carrier phase.

It is against this background that the present invention has arisen.

### SUMMARY OF THE INVENTION

According to an aspect of the present invention, there is provided a device for manipulating a microdroplet using optically-mediated electrowetting, the device comprising a microfluidic space bounded by:
a first composite wall comprising:
   a first substrate;
   a first conductor layer on the substrate;
   a photoactive layer on the first conductor layer; and
   a first continuous dielectric layer on the photoactive layer having a thickness of less than 20 nm;
a second composite wall comprising:
   a second substrate; and
   a second conductor layer on the substrate.

In some embodiments, the second composite wall further comprises a second continuous dielectric layer on the second conductor layer having a thickness of less than 20 nm.

In some embodiments, the first and second composite walls are held apart to form a microfluidic space therebetween. The walls can be separated by a spacer structure, which may be formed by an interposing structure between the first and second substrates, or it could be formed from the substrates of the first or second composite walls.

The spacer may be formed from a layer of photoresist, by a layer of pressure-sensitive adhesive and/or by a layer of dry-film resist. Additionally or alternatively, it may be formed by etching structures and/or cavities in to a glass, fused silica or transparent plastic substrate that forms the first or second composite walls.

According to another aspect of the present invention there is provided a device for manipulating a microdroplet using optically-mediated electrowetting, the device comprising:
a first composite wall comprising:
   a first substrate;
   a first conductor layer on the substrate;
   a photoactive layer on the conductor layer; and
   a first continuous dielectric layer on the photoactive layer having a thickness of less than 20 nm;
a second composite wall comprising:
   a second substrate;
   a second conductor layer on the substrate; and
   a second continuous dielectric layer on the second conductor layer having a thickness of less than 20 nm.

The design of devices for manipulating microdroplets using optically-mediated electrowetting is driven by a number of competing effects and observed phenomena. There is a well acknowledged super linear correlation between the speed of microdroplets and the voltage applied. The maximum voltage applied then dictates the dielectric thickness required. In order to optimise the speed of the microdroplets, it would therefore be expected that the voltage applied would be maximised and therefore the thickness of the dielectric would be increased to accommodate this. However, the inventors have found that high voltages have their own associated problems in relation to practical delivery.

Experimentally the inventors discovered that when increasing the applied voltage the maximum achievable oEWOD speed increases rapidly as expected. However, the inventors also observed that the ability to hold droplets stationary rapidly decreases with increasing voltage due to a previously unobserved driving force. Initially this presents as a characteristic random motion of the droplets around their target locations, as the voltage is increased further the speed of this random motion increases until this random motion overpowers the oEWOD holding force and control of the droplet is lost. This effectively imposes a maximum voltage thus reducing the maximum speed far below what is initially expect and predicted in the literature.

There are two states that dictate the voltage driven response of an oEWOD system, the “on” and the “off” states, corresponding to the illuminated and non-illuminated regions of the device. In an idealised oEWOD device the voltage applied in the on-regions of the device would be exactly nil, and only the ‘on’ state regions would apply a voltage. In an oEWOD device the spatially-varying optically controlled voltage on the surface alters the contact angle between the droplet and the surface and so imparts a driving force or a holding force on the droplet. When holding a droplet, the droplet will partially reside in the “on” state and partially in the ‘off’ state, with the spatial extent of each state determined by the size of the illuminated region. The contrast in voltage between the “on” and “off” states creates the holding force. As the applied voltage is increased the field strength of both states increases. The increase in field strength of the ‘on’ state leads to an increase in device performance as it increases the electrowetting force. The increase in field strength of the ‘off’ state will partially counteract this increase in force. However, as the ratio between these two states remains constant and the force depends on the square of the field there is an overall increase in the oEWOD force. Therefore, the literature teaches that with increasing voltage the skilled person would expect to see an improvement in both holding and droplet movement.

This is clearly in opposition to the observations by the inventors, where the inventors observe an increase in movement speed but a decrease in the ability to hold a droplet stationary with increasing voltage. Thus, the inventors theorise that this phenomenon is only explicable through a super-linear (faster than square) dependence of the unwanted driving force on the field strength of the “off” state. Therefore, the performance of the device, as disclosed herein, can be improved by designing the structure of the device to reduce the strength of the ‘off’ state rather than by maximising the strength of the ‘on’ state, as has been the focus of the literature within the field.

A logical approach to achieving this would be to increase the thickness of the photoactive layer. However, this is unsuitable for applications where a large number of droplets need to be manipulated simultaneously as it drastically increases the optical power requirements. Moreover, an increased thickness of the photoactive layer is inadequate for facilitating the parallel manipulation of many thousands of droplets simultaneously. Therefore rather than minimising the ‘off’ state through a change to the photoactive layer, the inventors explored the impact of the capacitance of the dielectric layer. In this counter-intuitive focus on the ‘off’ state, the inventors have found that by decreasing the thickness of the dielectric layer, a higher fraction of the voltage would drop across the photoconductive layer and hence, the field strength at the surface of the dielectric would decrease. The inventors have therefore reduced the dielectric thickness of device by approximately five times below what is recommended in the literature. This has resulted in a huge increase in device performance through mitigation of the ‘off’ state droplet holding failure mode allowing higher operational voltages to be reached and therefore higher oEWOD force, while requiring the same level of illumination.

The first dielectric layer may be deposited onto the photoactive layer by atomic layer deposition. Additionally or alternatively, the second dielectric layer may be deposited onto the photoactive layer.

Surprising it has been discovered that by providing the first and/or second dielectric layers with a continuous layer of thickness of less than 20 nm results in the droplets being more stable and therefore, the droplets are stationary on the substrate. In contrast, the inventors have found that increasing the first and/or second dielectric layers to a thickness of above 20 nm can result in more uncontrolled droplet movement on the substrate and therefore, droplets are more likely to exhibit uncontrolled motion deviating from the illuminated regions. As a consequence, uncontrolled droplets can make it more difficult for accurate and efficient oEWOD operations for example, merging or splitting of droplets. In some embodiments, the first and/or second dielectric layer may be a thickness of between 1 nm to 20 nm, or it may be 2 nm to 20 nm, 3 nm to 20 nm, 4 nm to 20 nm, 5 nm to 20 nm, 6 nm to 20 nm, 7 nm to 20 nm, 8 nm to 20 nm, 9 nm to 20 nm, 10 nm to 20 nm, 12 m to 20 nm, 14 nm to 20 nm, 15 nm to 20 m or 18 nm to 20 nm. It may also be 1 to 15 nm, 1 to 10 nm, 1 to 5 nm, 5 to 10 nm, 5 to 15 nm or 10 to 15 nm.

The first substrate and/or the second substrate may be transparent. The first conductor layer and/or the second conductor layer may be transparent.

The device may further comprise an Alternating Current (A/C) source to provide a voltage across the first and second composite walls connecting the first and second conductor layers; at least one source of electromagnetic radiation having an energy higher than the bandgap of a first photoexcitable layer adapted to impinge on the photoactive layer to induce corresponding ephemeral electrowetting locations on the surface of the first dielectric layer; and a microprocessor for controlling the source of electromagnetic radiation to manipulate the points of impingement of the electromagnetic radiation on the photoactive layer so as to vary the disposition of the ephemeral electrowetting locations thereby creating at least one electrowetting pathway along which the microdroplet may be caused to move.

The device may further comprise an interstitial layer of silicon oxide. The interstitial layer of silicon oxide is provided on the first and/or the second dielectric layers. The advantage of the interstitial layer is that it can be used as a binding layer for a anti or non-fouling layer. The interstitial layer is provided between the dielectric layer and the hydrophobic layer. The thickness of the interstitial layer may be between 0.1 nm to 5 nm. The thickness of the interstitial layer can be more than 0.1, 0.25, 0.5, 0.75, 1, 1.5, 2, 2.5, 3, 3.5, 4 or 4.5 nm, or it may be less than 5 nm, 4.5, 4, 3.5, 3, 2.5, 2, 1.5, 1, 0.75, 0.5 or 0.25 nm.

The exposed surfaces of the first and second composite walls may be disposed less than 200 μm apart to define a microfluidic space adapted to contain the microdroplet. The microfluidic space may be between 2 and 50 μm in width. In some embodiments, the microfluidic space is more than 2, 4, 6, 8, 10, 12, 14, 16, 18, 20, 22, 24, 26, 28, 30, 32, 34, 36, 38, 40, 42, 44, 46 or 48 μm. In some embodiments, the microfluidic space may be less than 50, 48, 46, 44, 42, 40, 38, 36, 34, 32, 30, 28, 26, 24, 22, 20, 18, 16, 14, 12, 10, 8, 6 or 4 μm.

The exposed surfaces of the first and second composite walls may include one or more spacers for holding the first and second walls apart by a predetermined amount to define a microfluidic space adapted to contain the microdroplet. The physical shape of the spacers may be used to aid the splitting, merging and elongation of microdroplets in the device. The spacer can be, but is not limited to, a blade shaped structure, a wedge structure, a pillar, a hydrophilic patch, a narrow channel, or it could be a surface dimple.

In some embodiments, the microdroplets may contain one or more cells. The microdroplets may also contain a medium, such as a cell medium and/or a buffer solution.

The A/C source may be configured to provide a voltage of between 0V and 100V across the first and second composite walls connecting the first and second conductor layers. In some embodiments, the voltage provided may be between 0V to 50V, 0.1 V, 0.1V to 2V, 3 to 4 V or it could be between 0V to 10V. In some embodiments, the A/C source can be configured to provide a voltage of more than 0, 5, 10, 15, 20, 25, 30, 35, 40, 50, 60, 70, 80 or 90 V or it may be less than 90, 80, 70, 60, 50, 45, 40, 35, 30, 25, 20, 15, 10 or 5V.

The first and second composite walls may further comprise first and second anti-fouling layers on respectively the first and second dielectric layers. The anti-fouling layer on the second dielectric layer may be hydrophobic.

The source(s) of electromagnetic radiation may comprise a pixelated array of light reflected from or transmitted through such an array.

The electrowetting locations may be crescent-shaped in the direction of travel of the microdroplets.

The device may further comprise a photodetector to detect an optical signal in the microdroplet located within or downstream of the device. The optical signal may be a fluorescence signal.

The device may further comprise an upstream inlet to generate a medium comprised of an emulsion of aqueous microdroplets in an immiscible carrier fluid. The carrier fluid may optionally be inert.

The device may further comprise an upstream inlet to induce a flow of a medium comprised of an emulsion of aqueous microdroplets in an immiscible carrier fluid through the microfluidic space via an inlet port into the microfluidic space.

The first and second composite walls which define the microfluidic space therebetween may form the periphery of a cartridge or chip.

The device may further comprise a plurality of first electrowetting pathways running concomitantly to each other.

The device may further comprise a plurality of second electrowetting pathways adapted to intersect with the first electrowetting pathways to create at least one microdroplet-coalescing location.

The device may further comprise an upstream inlet for introducing the microdroplet into the microfluidic space, in which the diameter of the microdroplet is more than 20% greater than the width of the microfluidic space.

The second composite wall may further comprise a second photoexcitable layer and the source of electromagnetic radiation may also impinge on the second photoexcitable layer to create a second pattern of ephemeral electrowetting locations which can also be varied.

The source of electromagnetic radiation may be an LED light source, which may provide electromagnetic radiation at a level of 0.005 to 0.1 Wcm⁻². In some embodiments, the source of electromagnetic radiation is at a level of 0.005 to 0.1 Wcm⁻², or it could be more than 0.005, 0.0075, 0.01, 0.025, 0.05 or 0.075 Wcm⁻².

In some embodiments, the source of electromagnetic radiation is at a level may be less than 0.1, 0.075, 0.05, 0.025, 0.01, 0.0075, 0.005 or 0.0025 Wcm⁻².

The first transparent conductor layer on the substrate may be a thickness in the range 70 to 250 nm. The photoactive layer may be activated by electromagnetic radiation in the wavelength range 400 to 1000 nm on the conductor layer, which may have a thickness in the range 300 to 1000 nm.

In some embodiments, the photoactive layer can be made out of amorphous silicon.

In some embodiments, microdroplets can be passed through a microfluidic space defined by two opposing walls where each of the walls includes a dielectric layer with a sufficiently low voltage applied across the dielectric layers so as to be below the dielectric breakdown voltage of the dielectric layers. The use of the two dielectric layers with a sufficiently low voltage across the dielectric layers not only prevents destructive ionization of conductive droplets but substantially eliminates the adverse effects of dielectric pinhole defects on the droplets which unexpectedly improves performance notwithstanding the reduction in electowetting forces resulting from the use of two dielectric layers. As a consequence, the optically-mediated electrowetting can be achieved using a low power source of illumination such as, for example, LEDs generating as low as 0.01 W/cm² for simultaneously manipulating thousands of droplets. In the case of an embodiment comprising a large-area microfluidic device with area greater than 1 cm×1 cm, the device is suitable for manipulating more than 10,000 droplets in parallel, more than 50,000 droplets, more than 100,000 droplets or more than 1,000,000 droplets in the case of a very large-area device.

In some embodiments a large area device can be utilised for handling many thousands of droplets. The inventors had tried to previously build a larger device using a single dielectric layer for handling droplets in parallel, however the inventors encountered defective areas where droplets could not move. Through experimentation and test, the inventors found pinhole defects to be an important limitation of device performance, especially as devices became larger.

The dielectric layers always have sparse pinhole defects, whereby they become conducting in a small, isolated region. Known optimized processes can give densities of circa 38 pinholes per cm². A pinhole defect can trap a droplet and make it impossible to move. The effect is more profound when using droplets of conducting media such as buffer solutions.

In some embodiments, there is provided a two dielectric layer structure that can be used below the dielectric breakdown. When run below the breakdown voltage, the two sided dielectric layer structure can give the novel effect of largely negating the effect of pinhole defects. With the dielectric disposed over both top and bottom of the droplets, a conducting path could only be formed if a pinhole defect in the first dielectric layer directly lined up with a pinhole defect in the second dielectric layer. The probability of this occurring is very, very small. This pinhole-mitigation feature achieved by the presence of the second dielectric layer is key to permitting the simultaneous manipulation of thousands of droplets in a relatively large area.

In the case of a large area device or a very large area device suitable for manipulating more than 100,000 droplets or even more than 1,000,000 droplets in parallel the number of pinhole defects becomes an important limitation in the device performance, because the probability of a single droplet contacting a pinhole defect becomes exceptionally high. A single droplet trapped on a pinhole defect may block the motion of other droplets in the device and so impair or interrupt the operation of the system. As such the advantage of the present invention in negating the effect of pinhole defects is exceptionally important in the operation of a very large area device containing large numbers of microdroplets.

According to another aspect of the present invention, there is provided a cartridge comprising: a reservoir containing a liquid sample; an emulsifier in a fluidic circuit with the reservoir, the emulsifier is configured to generate a medium comprised of an emulsion of aqueous microdroplets in an immiscible carrier fluid; an inlet channel provided downstream of the emulsifier, wherein the inlet channel is configured to receive the medium comprised of the emulsion of aqueous microdroplets in the immiscible carrier fluid from the emulsifier; a device according to any one of the aspects of the present invention, whereby the device comprises at least an inlet port and the device is in fluid communication with the inlet channel; and a pumping system provided to induce the flow of the liquid sample to the emulsifier and/or induce the flow of the medium comprised of the emulsion of aqueous microdroplets in the immiscible carrier fluid through the device.

Suitably, the aqueous fluids within the cartridge may be biological fluids such as cell media, and they may contain cells, beads, particles, drugs, biomolecules or other biological entities. These entities may be viruses, DNA or RNA molecules, stimulants, cytokines, nutrients and dissolved gases. As such the design of the cartridge channels and structures may be optimised such that the dispersion and integrity of the biological fluids is preserved, particularly by selection of well-matched channels of even hydraulic diameter and minimal fluid shear.

In some embodiments, the cartridge may further comprise one or more valves provided at the inlet port of the device, wherein the valve controls the flow of the medium, comprised of the emulsion of aqueous microdroplets in the immiscible carrier fluid, through the device.

In some embodiments, the emulsifier may be a step emulsifier. In some embodiments, several emulsifiers may be provided, each of which is provided with an inlet channel.

In some embodiments, the pumping system can include, but is not limited to, a pump, a head reservoir, an accumulator and/or a pressure source. It will be further appreciated that the skilled person in the art would know other pumping system that could be used to induce the flow of the liquid sample to the emulsifier and/or induce the flow of the medium through the device.

A number of technologies are known in the art for the formation of aqueous emulsions of microdroplets surrounded by an immiscible carrier phase. These include cross-flow emulsion generators, T-junction generators and step emulsification devices. Cross-flow emulsion generators, T-junction emulsion generators and other related devices are typically used to make microdroplets of variable sizes. The size distribution of the microdroplets is dependent on the flow conditions created at the junction where oil and aqueous material intersect. Furthermore, the microdroplet size is dependent on the fluid properties, such as the interfacial tensions and viscosities of the running fluids. As such, it is necessary to precisely control and adjust the flow rate of the fluids entering these types of emulsion generators in order to provide a uniform and repeatable size distribution of droplets into the oEWOD device.

Advantageously, a step emulsifier generates emulsion with a microdroplet size distribution that has a minimal dependency on the flow velocities at the emulsification junction. The size of the microdroplets is determined predominantly by the physical dimensions of the emulsification nozzle, as well as the material properties of the running fluids. Whilst both step emulsifiers and other emulsifiers are sensitive to the properties of the running fluids, the degree of dependency on interfacial tension and viscosity is considerably reduced in a step emulsifier device. As such, it is not necessary to precisely control and adjust flow parameters in order to correct the microdroplet size distribution emitting from the emulsifier. It can be operated with a simple fixed-flow-rate or fixed-pressure system. It is particularly suitable for operation with an oEWOD device because it avoids the requirement for inspection and optical access to an emulsifier device in a location, which might otherwise overlap with the optical assembly used for operation of the OEWOD device. It avoids the complexity and cost of introducing a plurality of inspection and microdroplet size monitoring devices in order to monitor and control a plurality of emulsifiers being operated within one cartridge assembly. Therefore, a number of independent step emulsifiers can be connected to different inlets on the oEWOD device to provide fluidically isolated emulsion-generating input paths between the aqueous input and the oEWOD device. The use of fluidically-isolated input paths allows for the oEWOD device to receive a set of independent emulsion inputs formed from different aqueous input materials without the possibility of cross-contamination between them.

In some embodiments, the cartridge assembly may contain up to eight emulsifiers. In some embodiments, the cartridge assembly may contain at least 1, 2, 3, 4, 5, 6 or 7 emulsifiers. In some embodiments, the cartridge assembly may contain between 8 and 12 emulsifiers. In some embodiments, the cartridge assembly may contain between 12 to 20, 20 to 30, 30 to 50 or 50 to 100 emulsifiers.

The emulsifiers may be interchangeable by the user such that the user can choose a suitable type of emulsifier for their intended purposes. For example, the user may configure a cartridge with emulsifiers that provide a particular microdroplet size range. The user may choose a set of emulsifiers each providing microdroplets with a different size range, or a sub-selection of size ranges. In some embodiments, the emulsifiers may be configured to generate microdroplets of volumes in the range 14 pL to 180 pL, or microdroplets in the range 180 pL to 500 pL, or in the range 500 pL to 1.2 nL. The emulsifiers may also be configured to provide microdroplets of volume less than 14 pL, particularly in the size range 10 fL to 50 fL or between 50 fL and 14 pL. In some embodiments, the emulsifiers may be configured to generate microdroplets of more than 1.2 nL, including at least the ranges of 1.2 nL to 4 nL. In the case where the emulsifiers are step emulsifiers, it is possible to alter the volume of the microdroplets by changing the geometry of the emulsification nozzle, particularly changing the height of the nozzle in the minor axis of the rectangular nozzle.

Furthermore, it is possible to parallelise the operation of a set of step emulsifier nozzles within a single emulsifier device, so that multiple emulsification nozzles are connected to a single aqueous input. The connected nozzles can run independently with variation in speeds determined by the complex interplay between the interconnected junctions. The emulsifiers can all generate microdroplets of substantially uniform size determined by the physical size of the nozzles. This allows for a large number of generators running in parallel at low flow velocities, eliminating the deleterious effects of shear that can damage cells and other biological materials. It also allows the emulsifier to continue generating emulsion despite the partial occlusion or blocking of some nozzles that is the occasional consequence of running biological material comprising particulates through narrow nozzle apertures.

According to an aspect of the present invention, there is provided a species screened by the device, apparatus, cartridge or method as disclosed herein.

According to an aspect of the present invention, there is provided a species selected by the device, apparatus, cartridge or method as disclosed herein.

According to an aspect of the present invention, there is provided a species isolated by the device, apparatus, cartridge or method as disclosed herein.

According to an aspect of the present invention, there is provided a species made by the device, apparatus, cartridge or method as disclosed herein.

The species may be chemical, biochemical, or biological in nature.

For example, the present invention may provide an agonist/antagonist to an entity as identified by the screening, selection and/or isolation method disclosed herein. The present invention may provide an agonist/antagonist to an entity as identified by the screening, selection and/or isolation method disclosed herein, for use in therapy. The entity may be chemical, biochemical, or biological in nature.

According to an aspect of the present invention, there is provided a use of the device, apparatus, cartridge, method or species as disclosed herein.

According to an aspect of the present invention, there is provided a use of the device, apparatus, cartridge, method or species as disclosed herein in therapy.

The present invention may provide for a use of the device, apparatus, cartridge, method or species as disclosed herein in making a product. The product made may be chemical, biochemical, or biological in nature.

The use may be peptide synthesis. The use may be synthetic biology. The use may be cell line engineering or development. The use may be cell therapy. The use may be drug discovery. The use may be antibody discovery.

According to an aspect of the present invention, there is provided a use of the device, apparatus, cartridge, method or species as disclosed herein in analysis.

The analysis may be physical, chemical, or biological.

The use may be sub-cellular imaging. The use may be high content imaging.

The use may be diagnostics.

The use may be a biological assay. The biological assay may be high throughput screening. The biological assay may be ELISA.

The use may be cell secretion.

The use may be QC safety profiling.

### FIGURES

The invention will now be further and more particularly described, by way of example only, and with reference to the accompanying drawings, in which:

FIG. 1A and FIG. 1B show two oEWOD device configurations according to the present invention;

FIG. 2 provides an equivalent circuit diagram for the oEWOD configuration shown schematically in FIGS. 1A and 1B;

FIG. 3 shows a voltage plot of the critical voltages within oEWOD devices having different thicknesses of dielectric layer;

FIG. 4 shows a flow-chart of the equilibrium of surfactant between various states within the oEWOD device; and

FIGS. 5A and 5B show the unwanted motion of droplets within oEWOD devices when they are held near-stationary.

### DETAILED DESCRIPTION

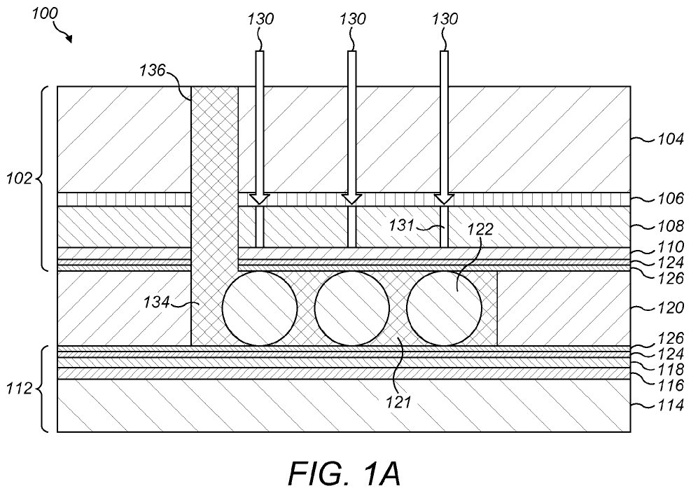

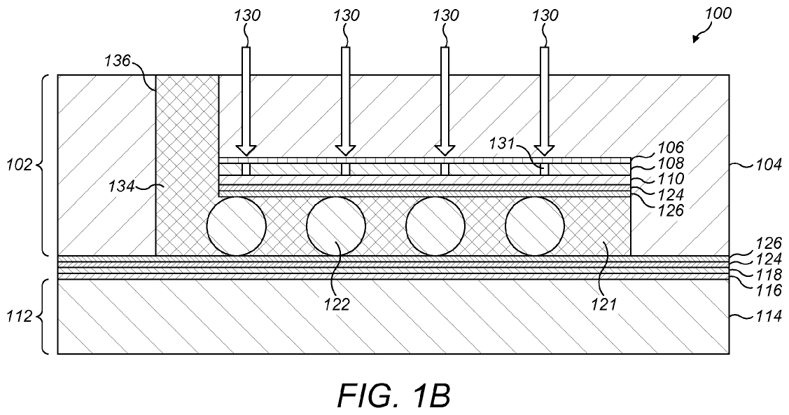

Referring to FIG. 1A, there is provided a microfluidic device and in particular, an oEWOD device 100. The oEWOD device as illustrated in FIG. 1A comprises: a first composite wall 102 comprised of a first substrate 104, which can be made out of glass, a first conductor layer 106 on the substrate 104, the first conductor layer 106 having a thickness in the range 70 to 250 nm; a photoactive layer 108 activated by electromagnetic radiation in the wavelength range 400-850 nm on the conductor layer 106, the photoactive layer 108 having a thickness in the range 300-1500 nm and a first dielectric layer 110 on the photoactive layer 108. The first dielectric layer 110 is formed as a continuous layer that has a thickness of less than 20 nm. The lower bound for the thickness of the layer will be dictated, at least in part, by the methodology of providing such a thin layer that must be continuous. However, theoretically it could have a thickness of between 0.1 nm to 20 nm. The first conductor can be transparent.

The device 100 also comprises a second composite wall 112 comprising: a second substrate 114, which can be made out of glass and a second conductor layer 116 on the substrate 114. The second conductor can be transparent. The second conductor layer 116 may have a thickness in the range 70 to 250 nm. A second dielectric layer 118 may be on the second conductor layer 116, where the second dielectric layer 118 has a thickness of less than 20 nm. As with the first dielectric layer, the second dielectric layer must be continuous and the practical lower bound for the thickness is dictated by manufacturing constraints although it could be between 1 nm to 20 nm. The exposed surfaces of the first 110 and second 118 continuous dielectric layers are disposed 20 to 180 μm apart to define a microfluidic space 121 adapted to contain microdroplets 122.

The photoactive layer 108 is made out of amorphous silicon. The first and second conductor layers are made out of ITO.

An interstitial binding layer 124 is provided on the first dielectric layer 110 and can also be provided on the second dielectric layer 118. The thickness of the interstitial layer may be between 0.1 nm to 5 nm. The thickness of the interstitial layer can be more than 0.1, 0.25, 0.5, 0.75, 1, 1.5, 2, 2.5, 3, 3.5, 4 or 4.5 nm, or it may be less than 5 nm, 4.5, 4, 3.5, 3, 2.5, 2, 1.5, 1, 0.75, 0.5 or 0.25 nm. The advantage of the interstitial layer is that it can be used as a binding layer for an anti-fouling or non-fouling layer, which may be hydrophobic. In some embodiments, not illustrated in the accompanying drawings, the interstitial binding layer may be omitted. In such embodiments, the hydrophobic layer is applied directly to the first dielectric layer.

A hydrophobic layer 126 is provided on the interstitial binding layer 124. An example of a hydrophobic layer could be a fluorosilane or fluorosiloxane. The interstitial binding layers 124 are optional and the channel walls 120 can be made of SU8, or it may be part of the glass structure. The interstitial layer 124 is provided between the dielectric layer 110, 118 and the hydrophobic layer 126.

An incident light 130, as illustrated in FIG. 1A, can be used to provide a light sprite pattern 131 in which the incident light 130 provides light onto a portion of the photoactive 110 to hold the microdroplet 122 into a stationary position within the microfluidic space 121. An oil carrier phase 134 can be provided to the microdroplets 122, through a hole 136 in the device, to replenish key nutrients and components to keep the contents within the microdroplet 122, such as one or more cells, alive and healthy. In some cases, the oil phase 134 can provide key nutrients, medium, media and contents for cell growth, viability and/or productivity.

The first and second substrates 104, 114 are made of a material which is mechanically strong. For example, the first and second substrates can be formed from glass, metal or an engineering plastic. In some embodiments, the substrates may have a degree of flexibility. In some embodiments, the first and second substrates have a thickness that is at least 100 μm. In some embodiments, the thickness of first and second substrates may be more than 2500 μm, for example 3000, 3500 or 4000 μm. In some embodiments, the first and second substrates can have a thickness in the range of 100 to 2500 μm. In some embodiments, the first and second substrate may have a thickness of more than 100, 200, 300, 400, 500, 600, 700, 800, 900, 1000, 1100, 1200, 1300, 1400, 1500, 1600, 1700, 1800, 1900, 2000, 2100, 2200, 2300 or 2400 μm. In some embodiments, the first and second substrate may have a thickness of less than 2500, 2400, 2300, 2200, 2100, 2000, 1900, 1800, 1700, 1600, 1500, 1400, 1300, 1200, 1100, 1000, 900, 800, 700, 600, 500, 400, 300 or 200 μm. In some embodiments, the first substrate has a thickness of approximately 1100 μm and the second substrate has a thickness of approximately 700 μm. In another embodiment, the first and second substrates can have a thickness of 800 microns. In some embodiments, the first substrate is Silicon, fused silica or glass. In some embodiments, the second substrate is fused silica and/or glass. The glass may be, but is not limited to, a soda lime glass or a float glass.

The first and second conductor layers 106, 116 are located on one surface of the first and second substrates 104, 114 and typically have a thickness in the range 70 to 250 nm, preferably 70 to 150 nm. At least one of these layers is made of a transparent conductive material such as Indium Tin Oxide (ITO), a very thin film of conductive metal such as silver or a conducting polymer such as PEDOT or the like. These layers may be formed as a continuous sheet or a series of discrete structures such as wires. Alternatively, the conductor layer may be a mesh of conductive material with the electromagnetic radiation being directed between the interstices of the mesh.

The photoactive layer 108 is formed from a semiconductor material which can generate localised areas of charge in response to stimulation by the source of electromagnetic radiation. Examples include hydrogenated amorphous silicon layers having a thickness in the range 300 to 1500 nm. In some embodiments, the photoactive layer is activated by the use of visible light. The dielectric properties of this layer preferably include a high dielectric strength of >10 7 V/m and a dielectric constant of >3. In some embodiments, the dielectric layer is selected from alumina, silica, hafnia or a thin non-conducting polymer film.

Alternatively, at least the first dielectric layer, preferably both, may be coated with an anti-fouling layer to assist in the establishing the desired microdroplet/carrier fluid/surface contact angle at the various virtual electrowetting electrode locations. The anti-fouling layer is intended additionally to prevent the contents of the microdroplets adhering to the surface and being diminished as the microdroplet is moved through the chip.

For optimum performance, the anti-fouling layer should assist in establishing a microdroplet/carrier fluid/surface contact angle that should be in the range 50° to 180° when measured as an air-liquid-surface three-point interface at 25° C. In some embodiments, these layer(s) have a thickness of less than 10 nm and are typically formed as a monomolecular layer. Alternatively, these layers may be comprised of a polymer of an acrylate ester such as methyl methacrylate or a derivative thereof substituted with hydrophobic groups; e.g. alkoxysilyl. Either or both of the anti-fouling layers are hydrophobic to ensure optimum performance. In some embodiments, an interstitial layer of silica of thickness less than 20 nm may be interposed between the anti-fouling coating and the dielectric layer in order to provide a chemically compatible bridge.

The first and second dielectric layers, and therefore the first and second walls, define a microfluidic space which is at least 10 μm, and preferably in the range of 20 to 180 μm, in width and in which the microdroplets are contained. Preferably, before they are contained, the microdroplets themselves have an intrinsic diameter, which is 10% greater or 20% greater, than the width of the microfluidic space. Thus, on entering the chip the microdroplets are caused to undergo compression leading to deformation of the spherical microdroplet that leads to enhanced electrowetting performance through e.g. a better microdroplet splitting capability. In some instances, the first and second dielectric layers can be coated with a hydrophobic coating such a fluorosilane.

In some embodiments, the microfluidic space includes one or more spacers for holding the first and second walls apart by a predetermined amount. Options for spacers include beads or pillars, ridges created from an intermediate resist layer which has been produced by photo-patterning. Alternatively, deposited material such as silicon oxide or silicon nitride may be used to create the spacers. Alternatively layers of film, including flexible plastic films with or without an adhesive coating, can be used to form a spacer layer. Various spacer geometries can be used to form narrow channels, tapered channels or partially enclosed channels which are defined by lines of pillars. By careful design, it is possible to use these spacers to aid in the deformation of the microdroplets, subsequently perform microdroplet splitting and effect operations on the deformed microdroplets. Similarly these spacers can be used to physically separate zones of the chip to prevent cross-contamination between droplet populations, and to promote the flow of droplets in the correct direction when loading the chip under hydraulic pressure.

The first and second walls are biased using a source of A/C power attached to the conductor layers to provide a voltage potential difference therebetween; suitably in the range 0 to 50 volts. These oEWOD structures are typically employed in association with a source of electromagnetic radiation having a wavelength in the range 400-850 nm, for example 550, 620 and 660 nm and an energy that exceeds the bandgap of the photoactive layer. Suitably, the photoactive layer will be activated at the virtual electrowetting electrode locations where the incident intensity of the radiation employed is in the range 0.005 to 0.1 Wcm⁻². The source of electromagnetic radiation is at a level of 0.005 to 0.1 Wcm⁻², or it could be more than 0.005, 0.0075, 0.01, 0.025, 0.05 or 0.075 Wcm⁻². In some embodiments, the source of electromagnetic radiation is at a level may be less than 0.1, 0.075, 0.05, 0.025, 0.01, 0.0075, 0.005 or 0.0025 Wcm⁻².

Where the sources of electromagnetic radiation are pixelated they are suitably supplied either directly or indirectly using a reflective screen such as a digital micromirror device (DMD) illuminated by light from LEDs or other lamps. This enables highly complex patterns of virtual electrowetting electrode locations to be rapidly created and destroyed on the first dielectric layer thereby enabling the microdroplets to be precisely steered along essentially any virtual pathway using closely-controlled electrowetting forces. Such electrowetting pathways can be viewed as being constructed from a continuum of virtual electrowetting electrode locations upon the first dielectric layer.

The first and the second dielectric layers may be composed of a single dielectric material or it may be a composite of two or more dielectric materials. The dielectric layers may be made from, but is not limited to, Al₂O₃ and SiO₂.

A structure may be provided between the first and second dielectric layers. The structure between the first and second dielectric layers can be made of, but is not limited to, epoxy, polymer, silicon or glass, or mixtures or composites thereof, with straight, angled, curved or micro-structured walls/faces. The structure between the first and second dielectric layers may be connected to the top and bottom composite walls to create a sealed microfluidic device and define the channels and regions within the device. The structure may occupy the gap between the two composite walls. Alternatively, or additionally, the conductor and dielectrics may be deposited on a shaped substrate which already has walls.

The oEWOD device 100 as illustrated in FIG. 1B provides an alternative oEWOD configuration. As shown in FIG. 1B, the oEWOD device comprises: a first composite wall 102 comprised of a first substrate 104, which can be made out of glass, a first conductor layer 106 on the substrate 104, the first conductor layer 106 having a thickness in the range 70 to 250 nm; a photoactive layer 108 activated by electromagnetic radiation in the wavelength range 400-850 nm on the conductor layer 106, the photoactive layer 108 having a thickness in the range 300-1500 nm and a first dielectric layer 110 on the photoactive layer 108. The first dielectric layer 110 is formed as a continuous layer that has a thickness of less than 20 nm.

The device 100 as shown in FIG. 1B also comprises a second composite wall 112 comprising: a second substrate 114, which can be made out of glass and a second conductor layer 116 on the substrate 114. The second conductor can be transparent. The second conductor layer 116 may have a thickness in the range 70 to 250 nm. A second dielectric layer 118 may be on the second conductor layer 116, where the second dielectric layer 118 has a thickness of less than 20 nm. As with the first dielectric layer, the second dielectric layer must be continuous and the practical lower bound for the thickness is dictated by manufacturing constraints although it could be between 1 nm to 20 nm. The exposed surfaces of the first 110 and second 118 continuous dielectric layers are disposed 20 to 180 μm apart to define a microfluidic space 121 adapted to contain microdroplets 122.

FIG. 1B shows an alternative embodiment of an oEWOD device 100, in which the spacer layer is not formed from a separate material, but is formed as part of a structure within the first (active) substrate 104. The sub layers of the oEWOD device formed from the first conductor layer 106, the photoactive layer 108, the first dielectric layer 110, interstitial binding layer 124 and hydrophobic layer 126 may partially or completely cover the walls of the spacer structure. A further embodiment is an alternative configuration of the device 100, in which the spacer layer is formed by structuring of the second (passive) substrate 114.

In some cases, the spacer may be formed by structuring both the first and/or second substrates 104, 114, or by using a combination of structures in the first and/or second substrates 104, 114 and an interposing material such as the channel walls 120, as illustrated in FIG. 1A.

An incident light 130, as illustrated in FIG. 1B, can be used to provide a light sprite pattern 131 in which the incident light 130 illuminates a portion of the photoactive layer 108 to hold the microdroplet 122 into a stationary position within the microfluidic space 121. An oil carrier phase 134 can be provided to the microdroplets 122, through a hole 136 in the device, to replenish key nutrients and components to keep the contents within the microdroplet 122, such as one or more cells, alive and healthy. In some cases, the oil phase 134 can provide key nutrients, medium, media and contents for cell growth, viability and/or productivity.

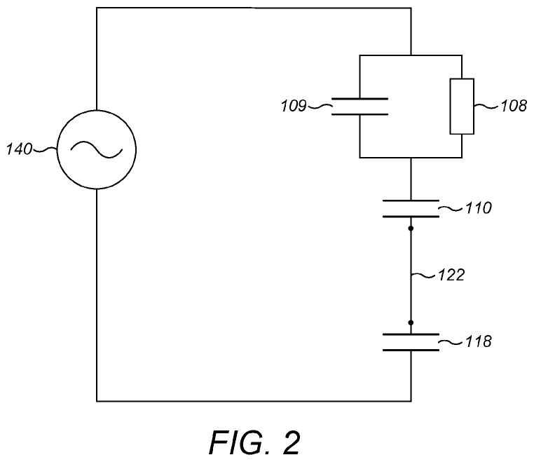

Referring to FIG. 2, there is shown an equivalent circuit diagram of the device of FIGS. 1A and 1B. FIG. 2 represents that photoactive layer using a light-dependent resistor 128 and a capacitor 129. Illumination reduces the resistance of the resistor 128 such that the resistor forms a conducting path. In the “off” state areas where the photoactive layer is un-illuminated, the resistor forms a substantially non-conducting path. Ideally, zero voltage is applied to the dielectric layer 118 during the “off” state or the applied voltage is near to zero as possible. As a result, in the equivalent circuit diagram of FIG. 2 the photoactive layer 108 contributes a considerable resistance and capacitance to the circuit. In the case of an idealised photoactive layer, in the “off” state the resistance would be infinitely high and would leave a purely capacitive element as a representation of the photoactive layer. In reality, all photoactive materials will have some resistance in the absence of illumination, as indicated in FIG. 2. Conversely in the “on” state indicated in FIG. 2, the illumination of the photoactive layer ideally leads to a conducting path across the photoactive layer 108. This should effectively eliminate the photoactive layer as a resistive and capacitive element and so subject the dielectric layer 110 below them to the full applied voltage. In the case of realistic, non-ideal photoactive layer, there will be a residual resistance in the illuminated portion of the photoactive layer, as the resistance of the photoactive layer 108 does not drop to zero.

When a non-zero voltage is applied during the “on” state, this voltage is used to hold the microdroplets 122 on their points of impingement or to drive movement of microdroplets along predefined electrowetting pathways. The difference between the “on” state voltage and the “off” state voltage affects the maximum speed at which the microdroplets can be manipulated.

During the “on” state, the photoactive layer 108 can provide an applied voltage to the dielectric layer 110 that is attenuated only by the residual resistance of the illuminated photoactive layer 108, whereas the “off” state provides a voltage that is substantially attenuated by the resistance of the un-illuminated photoactive layer. The electrowetting force exerted on each droplet is governed by the difference in contact angle between the illuminated and the non-illuminated portions of the microdroplet. In turn, the contact angle in each of those regions is determined by the applied voltage reaching the dielectric layer 110. As such, the residual resistance in the photoactive layer 108 in the “off” state will directly alter the contact angle in that portion of the microdroplet 122 and hence modify the electrowetting force. In the equivalent circuit model, the resulting voltage drop across the dielectric layer is the result of the interplay between the complex impedance of the photoactive layer 108 and the impedance of the dielectric layer 110. In the “on” state, light is provided to the microdroplet for the purpose of manipulating the microdroplet. The manipulation can include, but is not limited to, holding, moving, splitting, and merging of the microdroplets. A voltage source 140 can provide voltage to the microdroplet 122 to effect the movement of the microdroplet 122.

FIG. 2 illustrates the control of the “off” state and its role in the design optimisation of the device shown in FIGS. 1A and 1B. The optimisation of the “off” state voltage is a consideration which is relevant only to optically mediated electrowetting systems. The speed of the microdroplets 122 is at least partially dictated by the difference between the “on” state voltage and the “off” state voltage. Ideally, for optically mediated systems, the “off” state should tend towards 0V. The efficiency of the movement will also depend on the absolute voltage during each of the “on” and the “off” state. Movement will be more efficient where the voltage difference between the “on” and “off” states covers a considerable change in the extent of wetting. For example, if the “on” state is at 11V, there will be majority wetted in contrast to a 1V “off” state in which the array is totally unwetted. This can be contrasted with a scenario in which the “off” state is 100V and the array is fully wetted and therefore in the “on” state at 110V there is no change to the extent of wetting. Both of these scenarios have a 10V difference between the “on” and “off” state voltages, but the extent of wetting changes more over the 1-11V range. Therefore, in optically mediated systems, there is a desire to minimise the “off” voltage so that imaging can take place during the “off” phase. Within this voltage regimen, the optimal dielectric thickness is much thinner.

A further experimental phenomenon that has been observed when optimising the design of the device is the random movement of the microdroplets around their points of impingement. Without wishing to be bound by theory, it would appear that the microdroplets move randomly when the contrast between the “on” state voltage and the “off” state voltage is reduced. The random motion appears to be minimised in systems where the “off” state voltage tends to zero (0V). This can be achieved in conjunction with decreasing the capacitance of the system and therefore providing a thin dielectric layer rather than the much thicker dielectric layers which are taught in prior art.

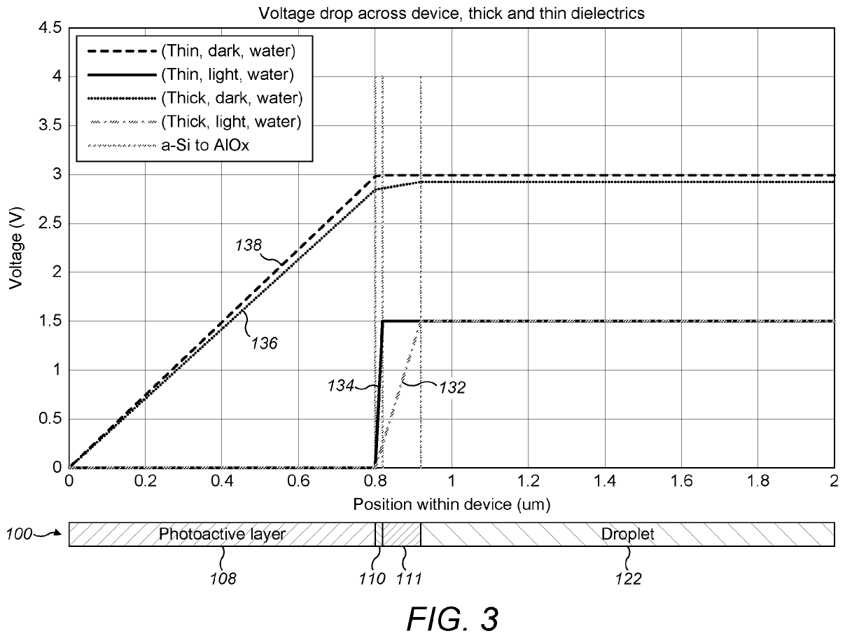

Referring to FIG. 3, there is shown an electric field gradient plot indicating the size of the field, and the field gradient across various places within the oEWOD device 100 comprising a photoactive layer 108 as shown in FIG. 3. In particular, the magnitude of the voltages is shown between an illuminated regions 132, 134 and an un-illuminated region 136, 138 for the case where the device has a dielectric layer with a thickness of 120 nm of aluminium oxide 111, and for a device having a dielectric layer with a thickness of less than 20 nm of aluminium oxide 110. The voltage plot is the output of a 1D model, which is constructed by calculating the applied voltage at each material boundary within the system and calculating the potential and hence field drop across each material block. The model has been calculated across a sub-region of the device in the region between the transparent conductor layer 116, as shown in FIG. 1A, and the base of the microdroplet 122, as shown in FIG. 1A, with a device comprising the dielectric layer 110 having a thickness of 20 nm (thin dielectric device), and a device comprising the dielectric layer 111 with a thickness of 120 nm (thick dielectric device).

When it is desired to use an oEWOD device at full performance, with the highest possible motion speed and the highest level of force applied to the droplets, it is necessary to increase the driving voltage, as governed by the equation:

$$F ∝ {C}_{d} {V}_{on , d}^{2} \qquad ( Equation 1 )$$

In which the electrowetting force F is proportional to the capacitance of the device Cd and the square of the on-state voltage V_{on,d}.

The maximum practical running voltage Vₘₐₓ for any given device is limited by the dielectric breakdown of the insulating layers; above the breakdown threshold there will be undesired electrolysis of the aqueous material that comprises the droplets.

$${V}_{max} = {dE}_{BD} \qquad ( Equation 2 )$$

Equation 2 above indicates that this maximum voltage Vₘₐₓ is the product of the dielectric thickness d and the dielectric breakdown strength E_{BD}

As such, oEWOD devices may be optimally run with maximum ford Fmax at voltages just below the breakdown threshold:

$${F}_{max} ∝ {dE}_{BD}^{2} \qquad ( Equation 3 )$$

The maximum level of electrowetting force that can ever be applied to a droplet would therefore follow the proportionality relationship of Equation 3.

However, for the particular case of driving droplet motion with oEWOD, there is another unexpected factor which is that the speed of droplet motion is determined not by the total electrowetting force, but by the localised field gradient across the dielectric below the droplet, particularly within the vicinity of the three-way contact line between the droplet, the carrier phase and the active oEWOD surface. Droplet motion in an oEWOD device is driven by an asymmetry in the surface energy between the illuminated and non-illuminated regions of the droplet; motion is the consequence of the droplet relaxing its surface energy to the lowest possible energy state. As such, the largest possible surface energy difference between illuminated and non-illuminated regions, which is increased by maximising the field gradient within the dielectric layer below the droplet, determines the speed of droplet motion.

The field gradients within this local contact-line region can be calculated as indicated previously in FIG. 2 for both the thick-dielectric devices 111 as known in the art and for the thin-dielectric device 110 as disclosed herein. When both devices are running at the same voltage e.g. the voltage being well below their breakdown threshold of both devices, the field gradient across the microdroplet is actually higher for a device with a thin dielectric layer 110, despite the same absolute field being present in the thick-dielectric 111 device. This increased field gradient across the microdroplet leads to faster and more controlled droplet motion at a fixed running voltage, meaning that the device comprising the thin-dielectric layer 110 as disclosed herein can be run effectively at a lower operating voltage.

Furthermore, there appear to be other confounding effects driven by field gradients within the device. It is therefore advantageous to have a device that runs at lower voltage in order to reduce these confounding effects, which will now be disclosed in more detail.

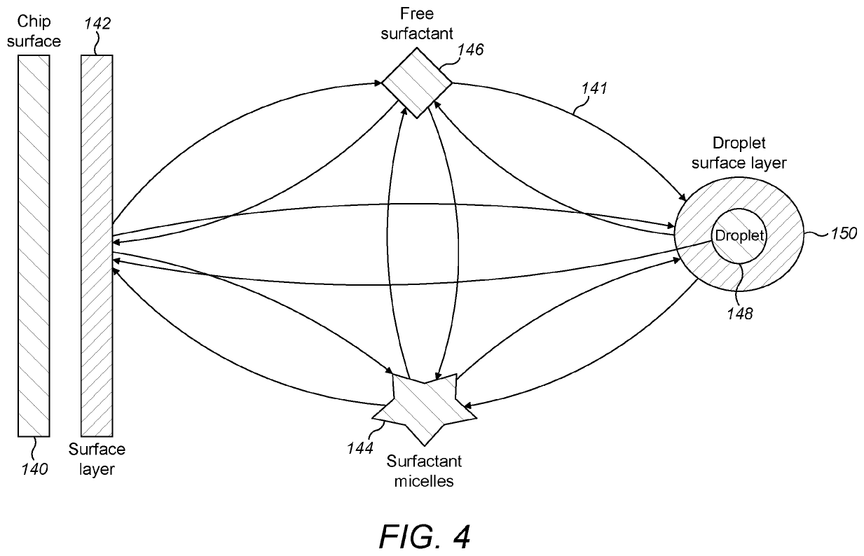

As well as a field gradient across the microdroplet, there can be an electric field gradient generated in the surrounding carrier phase. The carrier phase is a mixture of fluorocarbon oil, such as HFE7500, and a PEG-PFPE based triblock surfactant. This class of surfactant is well known to form complex molecular structures on the surface of chips and within the carrier phase. These structures will include Langmuir-Blodgett films on the chip interface, and it will include dimers, micelles, vesicles and other supramolecular structures (SUMOs) of surfactant within the carrier phase. There will be a multi-way equilibrium condition formed within the carrier phase between the surfactant molecules that are present as free surfactant, as oligomers, at a microdroplet surface layer and at the chip surface depletion layer. Transfer between any one of these states and any other is possible as they are all in direct fluid communication. This equilibrium and the associated interaction between the states is illustrated by the block diagram in FIG. 4.

As shown in FIG. 4, there is illustrated a diagram showing the interface between the chip surface 140 comprising the surface layer 142, surfactant micelle 144, free surfactant 146 and the microdroplet surface layer 148. Surfactant molecules 141, as indicated by arrows in FIG. 4, may transfer between the states of being on the chip interface 142, the droplet interface 148 and the two states in solution: in free-surfactant form as isolated molecules 146 and as supra-molecular structures such as micelles and dimers 144.

The presence of a field gradient within the carrier phase causes a second unexpected effect, which is the dielectrophoresis of non-dropletised material, particularly of the supra-molecular structures formed of surfactant such as micelles 144, vesicles and oligomers in the carrier phase. Around the contact line between the droplet 148 and the droplet surface 150, the aqueous droplet 148 will distort the local field, providing a gradient and so that supra-molecular structures within that gradient will be rapidly added to the droplet surface 150. There may also be a slower drift of SUMOs toward the chip surfaces 140. Given that the droplet is already being distorted by electrowetting forces, forcing the surfactant surfaces to distort and conceivably wrinkle, inducing the overloaded surfactant layers to coalesce into micelles, which will be expelled by capillary snapping, providing thrust. Once the droplet begins to move, it can encounter micelles by advection, and the same DEP forces rapidly layer them onto the leading surface. At the rear surface of the microdroplet, the surfactant accumulates because of the droplet surface flow, leading to surface thrust. This is a feedback cycle that can give speeds of several cm s⁻¹. The rear surface of the microdroplet will remain anisotropically layered in surfactant for a considerable time after the forcing field is removed.

The result of this field-gradient-driven acceleration is that microdroplets will be moved through a force that is not determined by the optical electrowetting control; it can be caused in non-illuminated regions and in partially-illuminated microdroplets. It can manifest as microdroplets moving in an uncontrolled fashion. This uncontrolled motion can in extreme cases detach microdroplets from their holding sprites and move them considerable distances within the chip. Microdroplets that are moving due to this unwanted effect can then disrupt the retention of other microdroplets within the device.

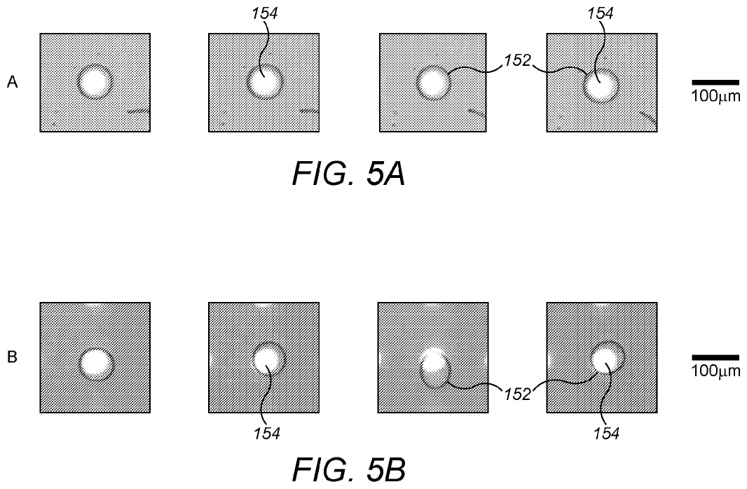

This effect, and the optimal behaviour of the present invention in order to mitigate it, is further illustrated as FIGS. 5A and 5B, which show a series of time-lapse photomicrographs illustrating the droplet motion on two different devices. Both thin dielectric (FIG. 5A) and thick dielectric (FIG. 5B) devices have been filled with aqueous droplets 152 of diameter approximately 70 μm which are then trapped on oEWOD illumination spots or sprite 154 and held within the device by the combination of light and external voltage (not shown in the accompanying drawings) applied to the conductor layers of the device.

The droplets 152 in FIG. 5A are being held stationary under a voltage of 5V in a thin-dielectric device having dielectric thickness layer of approximately 20 nm. Under these conditions, the device can be caused move the droplets 152 in excess of 4 mm/s across the surface under oEWOD control. The three images in the time-lapse sequence are taken 1s apart, and in this time interval the droplet has moved a distance of less than 1/10^{th} of its diameter away from the sprite 154. When the droplets 152 are retained, there is very little motion of the droplet 152 around the central light-holding spot or sprite 154.

FIG. 5B shows the results of running a similar test on a thick-dielectric device having a dielectric thickness layer of 120 nm, as known in the art. The device is run at an AC bias of 10V and the droplet motion speed can be as high as 3 mm/s. However, under these conditions there is a substantial degree of droplet motion around the holding sprites 154 when the oEWOD forces are being used to retain the droplets 152 in a stationary position. The timelapse images of FIG. 5B are again taken at 1s intervals, but in this timeframe the droplets 152 have been substantially displaced from their holding spots 154 by the effects of dielectrophoresis of the supra-molecular surfactant structures contained in the surrounding carrier phase. At the extreme end of the motion the droplet 152 is displaced by as much as half its diameter away from the sprite 154. This deleterious effect on devices with thick dielectric layers, as illustrated in FIG. 5B, is not observed in devices with thin dielectric layers i.e. less than 20 nm thickness as illustrated in FIG. 5A.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments, it is not limited to the disclosed embodiments and that alternative embodiments could be constructed without departing from the scope of the invention as defined in the appended claims.

1-30. (canceled)

31. A device for manipulating a microdroplet using optically-mediated electrowetting, the device comprising a microfluidic space bounded by:
a first composite wall comprising:
a first substrate;
a first conductor layer on the substrate;
a photoactive layer on the first conductor layer; and
a first continuous dielectric layer on the photoactive layer having a thickness of less than 20 nm;
a second composite wall comprising:
a second substrate; and
a second conductor layer on the substrate.

32. The device according to claim 31, wherein the second composite wall further comprises a second continuous dielectric layer on the second conductor layer having a thickness of less than 20 nm.

33. The device according to claim 31, further comprising:
an A/C source to provide a voltage across the first and second composite walls connecting the first and second conductor layers;
at least one source of electromagnetic radiation having an energy higher than the bandgap of a first photoexcitable layer adapted to impinge on the photoactive layer to induce corresponding ephemeral electrowetting locations on the surface of the first dielectric layer; and
a microprocessor for controlling the source of electromagnetic radiation to manipulate the points of impingement of the electromagnetic radiation on the photoactive layer so as to vary the disposition of the ephemeral electrowetting locations thereby creating at least one electrowetting pathway along which the microdroplet may be caused to move.

34. The device according to claim 31, further comprising an interstitial layer of silicon oxide provided on the first and/or the second dielectric layers, wherein the thickness of the interstitial layer is between 0.1 nm to 5 nm.

35. The device according to claim 31, wherein the exposed surfaces of the first and second composite walls are disposed less than 200 μm apart to define a microfluidic space adapted to contain the microdroplet, wherein the microfluidic space is from 2 to 50 μm.

36. The device according to claim 31, wherein exposed surfaces of the first and second composite walls include one or more spacers for holding the first and second walls apart by a predetermined amount to define a microfluidic space adapted to contain the microdroplet.

37. The device according to claim 31, wherein the A/C source is configured to provide a voltage of between 0V and 50V across the first and second composite walls connecting the first and second conductor layers.

38. The device according to claim 31, wherein the first and second composite walls further comprise first and second anti-fouling layers on respectively the first and second dielectric layers, wherein the anti-fouling layers on the first and second dielectric layers are hydrophobic.

39. The device according to claim 33, wherein the source(s) of electromagnetic radiation comprise a pixelated array of light reflected from or transmitted through such an array.

40. The device according to claim 31, further comprising a photodetector to detect an optical signal in the microdroplet located within or downstream of the device.

41. The device according to claim 31, further comprising a plurality of first electrowetting pathways running concomitantly to each other.

42. The device according to claim 31, further comprising a plurality of second electrowetting pathways adapted to intersect with the first electrowetting pathways to create at least one microdroplet-coalescing location.

43. The device according to claim 31, wherein the second composite wall further comprises a second photoexcitable layer and the source of electromagnetic radiation also impinges on the second photoexcitable layer to create a second pattern of ephemeral electrowetting locations which can also be varied.

44. The device according to claim 31, wherein the source of electromagnetic radiation is an LED light source.

45. The device according to claim 31, wherein the source of electromagnetic radiation is at a level of 0.005 to 0.1 Wcm⁻².

46. The device according to claim 31, wherein the first conductor layer on the first substrate is transparent and has a thickness in the range 70 to 250 nm.

47. The device according to claim 31, wherein the photoactive layer is activated by electromagnetic radiation in the wavelength range 400 to 1000 nm.

48. A cartridge comprising
a reservoir containing a liquid sample;
an emulsifier in a fluidic circuit with the reservoir, the emulsifier is configured to generate a medium comprised of an emulsion of aqueous microdroplets in an immiscible carrier fluid;
an inlet channel provided downstream of the emulsifier, wherein the inlet channel is configured to receive the medium comprised of the emulsion of aqueous microdroplets in the immiscible carrier fluid from the emulsifier;
a device comprising a microfluidic space bounded by:
a first composite wall comprising:
a first substrate;
a first conductor layer on the substrate;
a photoactive layer on the first conductor layer; and
a first continuous dielectric layer on the photoactive layer having a thickness of less than 20 nm;
a second composite wall comprising:
a second substrate; and
a second conductor layer on the substrate, whereby the device comprises at least an inlet port and the device is in fluid communication with the inlet channel; and
a pumping system provided to induce the flow of the liquid sample to the emulsifier and/or induce the flow of the medium comprised of the emulsion of aqueous microdroplets in the immiscible carrier fluid through the device.

49. The cartridge according to claim 48, further comprising one or more valves provided at the inlet port of the device, wherein the valve controls the flow of the medium, comprised of the emulsion of aqueous microdroplets in the immiscible carrier fluid, through the device.

50. The cartridge according to claim 49, wherein the emulsifier is a step emulsifier.
